(19) United States
(12) Patent Application Publication
(10) Pub. No.: US 2019/0391523 A1
(43) Pub. Date: Dec. 26, 2019

(54) IMAGE FORMING APPARATUS

(71) Applicant: Konica Minolta, Inc., Tokyo (JP)

(72) Inventor: Hisashi MURATA, Toyohashi-shi (JP)

(21) Appl. No.: 16/428,080

(22) Filed: May 31, 2019

(30) Foreign Application Priority Data
Jun. 22, 2018 (JP) 2018-118590

(51) Int. Cl. G03G 21/00; G03G 15/02; G03G 15/00

(52) U.S. Cl. CPC G03G 21/0029; G03G 15/5004; G03G 15/0233

(57) ABSTRACT

An image forming apparatus includes an image carrier, a first charging portion and a cleaning portion. The image carrier is configured to be rotatable. The cleaning portion is configured to come into contact with the image carrier to thereby clean the image carrier. The first charging portion is arranged on a downstream side of the cleaning portion in a rotation direction of the image carrier. The first charging portion is configured to charge the image carrier. The first charging portion is provided at the cleaning portion. A voltage is applied to the image carrier by the first charging portion, and the cleaning portion is thereby pressed against the image carrier.

The entire disclosure of Japanese Patent Application No. 2018-118590, filed on Jun. 22, 2018, is incorporated herein by reference in its entirety.

### BACKGROUND

### Technological Field

The present disclosure relates to an image forming apparatus.

### Description of the Related Art

Japanese Laid-Open Patent Publication No. 2002-132022 and Japanese Laid-Open Patent Publication No. 2004-85888 each discloses the technique relating to a cleaning blade configured to clean an image carrier in a conventional image forming apparatus.

### SUMMARY

When the cleaning blade disclosed in each of Japanese Laid-Open Patent Publication No. 2002-132022 and Japanese Laid-Open Patent Publication No. 2004-85888 is used for a long period of time, the blade wears out and thus the cleaning ability decreases. The decrease in cleaning ability may cause image noise due to the occurrence of an uncleaned part or the like. Therefore, when the cleaning ability of the blade decreases, replacement of the cleaning blade is required.

If the frequency of replacement of the cleaning blade can be reduced, the cost of the image forming apparatus can be reduced. Therefore, there is a demand for reducing the frequency of replacement of the cleaning blade.

An object of the present disclosure is to provide an image forming apparatus with reduced cost.

To achieve at least one of the abovementioned objects, according to an aspect of the present disclosure, an image forming apparatus reflecting one aspect of the present disclosure comprises an image carrier, a first charging portion and a cleaning portion. The image carrier is configured to be rotatable. The cleaning portion is configured to come into contact with the image carrier to thereby clean the image carrier. The first charging portion is arranged on a downstream side of the cleaning portion in a rotation direction of the image carrier. The first charging portion is configured to charge the image carrier. The first charging portion is provided at the cleaning portion. A voltage is applied to the image carrier by the first charging portion, and the cleaning portion is thereby pressed against the image carrier.

### BRIEF DESCRIPTION OF THE DRAWINGS

The advantages and features provided by one or more embodiments of the disclosure will become more fully understood from the detailed description given hereinbelow and the appended drawings which are given by way of illustration only, and thus are not intended as a definition of the limits of the present disclosure.

FIG. 1 is a schematic view of an image forming apparatus according to an embodiment.

FIG. 2 is an enlarged schematic view of a region II shown in FIG. 1.

FIG. 3 shows the relation between an applied voltage and the electrostatic attraction force for each material used in a potential unevenness removing sheet.

FIG. 4 shows a result of a test conducted to determine a proper range of a potential unevenness removing voltage.

FIG. 5 shows a range of a voltage Ve applied to the potential unevenness removing sheet, to ensure both the potential unevenness removing ability and the cleaning ability.

FIG. 6 is a schematic view of an imaging unit according to a second embodiment.

FIG. 7 is a schematic view of an imaging unit according to a third embodiment.

### DETAILED DESCRIPTION OF EMBODIMENTS

Hereinafter, one or more embodiments of the present disclosure will be described with reference to the drawings. However, the scope of the disclosure is not limited to the disclosed embodiments.

Hereinafter, embodiments will be described in detail with reference to the drawings. In the embodiments described below, a so-called tandem-type color printer using the electrophotography technique and an image forming apparatus included therein will be described as an image forming apparatus by way of example. In the embodiments described below, the same or common components will be denoted by the same reference characters in the drawings and description thereof will not be repeated.

### First Embodiment

<Image Forming Apparatus 100>

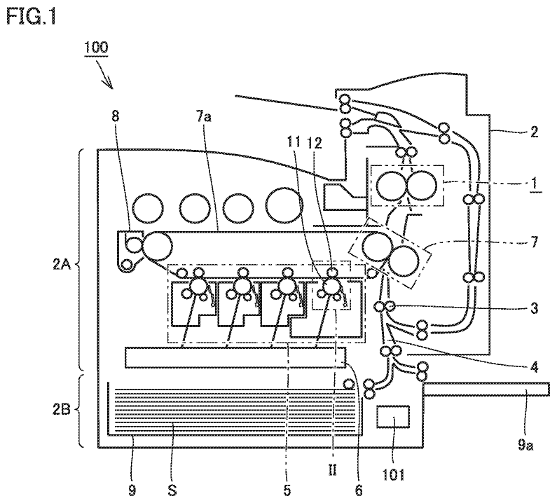

FIG. 1 is a schematic view of an image forming apparatus 100 according to an embodiment. Referring to FIG. 1, schematic configuration and operation of image forming apparatus 100 according to the embodiment will be described.

Image forming apparatus 100 mainly includes an apparatus main body 2, a housing portion 9 and a control device 101. Apparatus main body 2 includes an image forming portion 2A configured to form an image on a sheet of paper S serving as a recording medium, and a paper feeding portion 2B configured to feed a sheet of paper S to image forming portion 2A. Housing portion 9 is configured to house sheets of paper S to be fed to image forming portion 2A, and is detachably provided in paper feeding portion 2B.

A plurality of rollers 3 are placed in image forming apparatus 100, and thus, a conveyance route 4 via which a sheet of paper S is conveyed along a prescribed direction is formed to extend across image forming portion 2A and paper feeding portion 2B described above. As shown in FIG. 1, apparatus main body 2 may be separately provided with a manual feed tray 9a configured to feed a sheet of paper S to image forming portion 2A.

Image forming portion 2A mainly includes an imaging unit 5 configured to be capable of forming a toner image of each color of, for example, yellow (Y), magenta (M), cyan (C), and black (K), an exposure unit 6 configured to expose an image carrier 11 included in imaging unit 5, an intermediate transfer belt 7a stretched over imaging unit 5, a secondary transfer portion 7 provided on conveyance route 4 and on the course of intermediate transfer belt 7a, a belt cleaning portion 8, and a fixing device 1 provided on conveyance route 4 on the downstream side of secondary transfer portion 7.

Control device 101 controls image forming apparatus 100 as a whole. Control device 101 transmits a signal corresponding to an image formed on a sheet of paper S to exposure unit 6. Based on the signal from control device 101, exposure unit 6 drives each of exposure means (means using a polygon mirror and a laser beam, or a line light emitting element of an LED) for the respective colors.

Imaging unit 5 includes image carrier 11 configured to be rotatable Imaging unit 5 is subjected to exposure by exposure unit 6 and forms a toner image of each color of yellow (Y), magenta (M), cyan (C), and black (K), or a toner image of only a color of black (K) on a surface of image carrier 11. The above-described toner image of each color is transferred to intermediate transfer belt 7a by each primary transfer roller 12 (so-called primary transfer). As a result, a color toner image or a monochrome toner image is formed on intermediate transfer belt 7a. The details of imaging unit 5 will be described below.

Intermediate transfer belt 7a transports the color toner image or the monochrome toner image formed on a surface of intermediate transfer belt 7a to secondary transfer portion 7, and in secondary transfer portion 7, the color toner image or the monochrome toner image is pressed against the sheet of paper S conveyed from paper feeding portion 2B to secondary transfer portion 7. As a result, the color toner image or the monochrome toner image formed on the surface of intermediate transfer belt 7a is transferred to the sheet of paper S (so-called secondary transfer).

After the color toner image or the monochrome toner image is transferred to the sheet of paper S by secondary transfer portion 7, the residual toner of intermediate transfer belt 7a that has curvature-separated the sheet of paper S is removed by belt cleaning portion 8.

The sheet of paper S having the color toner image or the monochrome toner image transferred thereon is then pressurized and heated by fixing device 1, to thereby fix the toner image formed on the sheet of paper S. As a result, a color image or a monochrome image is formed on the sheet of paper S. The sheet of paper S having the color image or the monochrome image formed thereon is then discharged from apparatus main body 2.

<Imaging Unit 5>

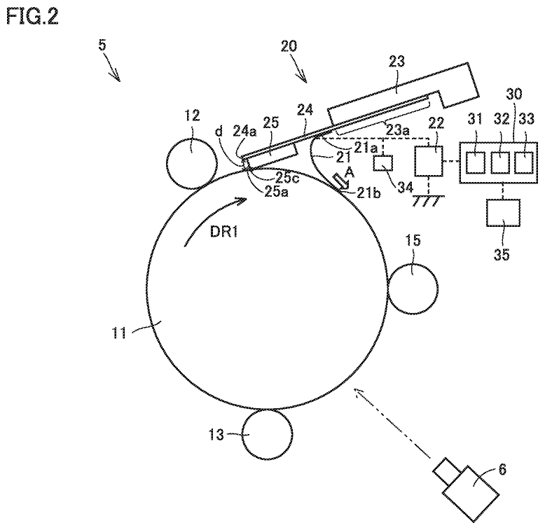

FIG. 2 is an enlarged schematic view of a region II shown in FIG. 1. FIG. 2 schematically shows an enlarged view of image carrier 11 and its surroundings. FIG. 2 does not show intermediate transfer belt 7a. A rotation direction DR1 in FIG. 2 corresponds to a rotation direction of image carrier 11.

Imaging unit 5 further includes a first charging portion, a cleaning portion 20, a second charging portion 15, and a developing device 13. Cleaning portion 20, the first charging portion (potential unevenness removing sheet 21 described below), second charging portion 15, developing device 13, and primary transfer roller 12 are arranged in this order along rotation direction DR1.

In the embodiment, the first charging portion has a sheet shape. In the embodiment, the first charging portion corresponds to potential unevenness removing sheet 21. Potential unevenness removing sheet 21 charges image carrier 11. A negative-polarity voltage is applied to image carrier 11 by potential unevenness removing sheet 21. Potential unevenness removing sheet 21 applies the voltage to image carrier 11 to make a potential of image carrier 11 uniform, thereby removing potential unevenness. The details of potential unevenness removing sheet 21 will be described below.

Second charging portion 15 is arranged on the downstream side of potential unevenness removing sheet 21 in rotation direction DR1. Second charging portion 15 charges image carrier 11. After second charging portion 15 charges image carrier 11, exposure unit 6 emits light toward image carrier 11, and an electrostatic latent image is thus formed on the surface of image carrier 11.

Developing device 13 supplies a developer to image carrier 11. As a result, a toner image is formed on the surface of image carrier 11. The toner image is primary-transferred to not-shown intermediate transfer belt 7a by primary transfer roller 12 arranged on the downstream side of developing device 13 in rotation direction DR1. The toner (transfer residual toner) that has not been transferred to intermediate transfer belt 7a remains on the surface of image carrier 11 after primary transfer.

Cleaning portion 20 arranged on the downstream side of primary transfer roller 12 in rotation direction DR1 cleans the transfer residual toner. Cleaning portion 20 comes into contact with image carrier 11 to thereby clean image carrier 11.

Cleaning portion 20 has an elastic portion 25, a plate spring 24 and a holder 23. Elastic portion 25 is formed of an elastic body. Elastic portion 25 has a plate shape. Elastic portion 25 is in contact with the surface of image carrier 11. Elastic portion 25 has a tip 25a. Tip 25a is an end closer to image carrier 11 when viewed in an axial direction of image carrier 11. Elastic portion 25 is joined to plate spring 24.

Plate spring 24 has a plate shape. Plate spring 24 supports elastic portion 25. Plate spring 24 has a tip 24a. Tip 24a is an end closer to image carrier 11 when viewed in the axial direction of image carrier 11. Tip 24a is provided to protrude from tip 25a of elastic portion 25, when viewed in the axial direction of image carrier 11.

Tip 24a is provided to be more distant from holder 23 than tip 25a.

Tip 24a is provided to prevent discharge from occurring between tip 24a and image carrier 11. A distance (d in FIG. 2) between tip 24a and the surface of image carrier 11 is kept to such an extent that discharge does not occur in accordance with the Paschen's law. Tip 24a is preferably covered with an elastic member.

A position of holder 23 is fixed. Holder 23 holds plate spring 24. Holder 23 is joined to plate spring 24. Holder 23 is provided with a joined region 23a where plate spring 24 and holder 23 are joined.

(Potential Unevenness Removing Sheet 21)

Potential unevenness removing sheet 21 is provided at cleaning portion 20. Potential unevenness removing sheet 21 has one end 21a which is a fixed end, and the other end 21b which is a free end. One end 21a is joined to plate spring 24. Potential unevenness removing sheet 21 is provided to be joined to plate spring 24.

Potential unevenness removing sheet 21 is joined to plate spring 24 by, for example, an electrically conductive member. Examples of a manner of joining potential unevenness removing sheet 21 and plate spring 24 include welding, an adhesive, a copper tape, and the like, and welding is preferable.

The other end 21b is in contact with the surface of image carrier 11. During rotation of image carrier 11, potential unevenness removing sheet 21 is deformed to bow along the surface of image carrier 11. A tip of the other end 21b faces toward the downstream side in rotation direction DR1. During rotation of image carrier 11, the other end 21b slides on the surface of image carrier 11.

The other end 21b is provided on the downstream side of a contact portion 25c of elastic portion 25 and image carrier 11 in rotation direction DR1. Potential unevenness removing sheet 21 is arranged on the downstream side of cleaning portion 20 (elastic portion 25) in rotation direction DR1.

Potential unevenness removing sheet 21 is attached to the elastic portion 25 side with respect to the joined portion (joined region 23a ) of plate spring 24 and holder 23, when viewed in the axial direction of image carrier 11. One end 21a of potential unevenness removing sheet 21 is provided at a distance from joined region 23a toward the elastic portion 25 side. One end 21a is provided between joined region 23a and elastic portion 25, when viewed in the axial direction of image carrier 11.

(Electrostatic Attraction Force of Potential Unevenness Removing Sheet 21)

Image forming apparatus 100 further includes a power supply portion 22. Potential unevenness removing sheet 21 is electrically connected to power supply portion 22 (in FIG. 2, an electrically connected state is shown with a dotted line). Power supply portion 22 applies a voltage to potential unevenness removing sheet 21. When the voltage is applied to potential unevenness removing sheet 21, the voltage is also applied to plate spring 24 as a whole. When the voltage is applied to potential unevenness removing sheet 21, the electrostatic attraction force is generated between the other end 21b of potential unevenness removing sheet 21 and image carrier 11.

When image carrier 11 rotates with the other end 21b and image carrier 11 being attracted each other, the other end 21b is pulled in a direction of a tangent at the contact point of the other end 21b and image carrier 11 (direction of a white arrow A in FIG. 2). When potential unevenness removing sheet 21 (the other end 21b ) is pulled, plate spring 24 provided to be joined to potential unevenness removing sheet 21 is pulled toward image carrier 11.

As a result, elastic portion 25 is pressed against image carrier 11, and a contact pressure between elastic portion 25 and image carrier 11 increases. As described above, when the prescribed voltage is applied to image carrier 11 by potential unevenness removing sheet 21, cleaning portion 20 (elastic portion 25) is pressed against image carrier 11.

In addition to the conventional potential unevenness removing function, potential unevenness removing sheet 21 according to the present disclosure further has the function of increasing the above-described contact pressure. In image forming apparatus 100 according to the present disclosure, the applied voltage for removing potential unevenness is also used as the applied voltage for increasing the above-described contact pressure.

At the timing after the toner image is transferred to intermediate transfer belt 7a by primary transfer roller 12, the voltage is applied to potential unevenness removing sheet 21. When the voltage is applied to potential unevenness removing sheet 21, cleaning portion 20 is pressed against image carrier 11 and cleaning portion 20 cleans the transfer residual toner. Potential unevenness removing sheet 21 removes potential unevenness from the surface of image carrier 11 subjected to cleaning by cleaning portion 20.

Cleaning portion 20 is placed such that the above-described contact pressure is set at a central value within a proper range when the voltage is applied to potential unevenness removing sheet 21.

(Material of Potential Unevenness Removing Sheet 21)

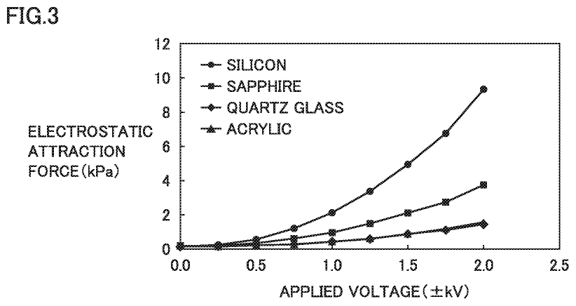

FIG. 3 shows the relation between the applied voltage and the electrostatic attraction force for each material used in potential unevenness removing sheet 21. FIG. 3 shows the case in which a material of potential unevenness removing sheet 21 is acrylic, quartz glass, sapphire, and silicon. A thickness of a dielectric layer of potential unevenness removing sheet 21 is set at 100 [μm].

As the voltage applied to potential unevenness removing sheet 21 becomes higher, the electrostatic attraction force of potential unevenness removing sheet 21 becomes greater. Particularly when silicon is used as the material of potential unevenness removing sheet 21, the great electrostatic attraction force is obtained even with a low voltage. The material of potential unevenness removing sheet 21 is preferably silicon.

(Controller 30)

As shown in FIG. 2, image forming apparatus 100 further includes a controller 30, a current detecting portion 34 and a printing durability quantity detecting portion 35. Controller 30 is connected to power supply portion 22. Controller 30 is connected to printing durability quantity detecting portion 35. Printing durability quantity detecting portion 35 detects a printing durability quantity of image carrier 11. Examples of the printing durability quantity of image carrier 11 include the cumulative number of recording media printed using image carrier 11 (printing durability number of sheets of paper), the cumulative rotation number or cumulative rotation time of image carrier 11, a cumulative developer quantity consumed by printing using image carrier 11, and the like.

During formation of an image, the information about the printing durability quantity of image carrier 11 is transmitted from printing durability quantity detecting portion 35 to controller 30. In accordance with the printing durability quantity obtained from printing durability quantity detecting portion 35, controller 30 controls an output voltage of power supply portion 22. As a result, the adjusted voltage is applied to potential unevenness removing sheet 21.

Controller 30 includes a first controller 31, a second controller 32 and a third controller 33. First controller 31 controls the output voltage of power supply portion 22 in accordance with the printing durability number of sheets of paper (the cumulative number of recording media printed before cleaning portion 20 reaches the end of the life) obtained at printing durability quantity detecting portion 35. First controller 31 controls the output voltage of power supply portion 22 such that a high voltage is applied to potential unevenness removing sheet 21 when the printing durability number of sheets of paper increases.

Second controller 32 controls the output voltage of power supply portion 22 in accordance with a change in at least one of temperature and humidity around cleaning portion 20 obtained by a not-shown temperature and humidity detecting portion.

Current detecting portion 34 detects a current flowing through potential unevenness removing sheet 21. Based on a value of the current flowing through potential unevenness removing sheet 21, a film thickness of image carrier 11 can be estimated. Third controller 33 detects the life of cleaning portion 20 in accordance with the result of current detecting portion 34 (current value obtained by current detecting portion 34).

### EXAMPLES

When potential unevenness removing sheet 21 removes potential unevenness from image carrier 11, there is a proper range for the voltage applied to potential unevenness removing sheet 21. A test for determining a proper range of a potential unevenness removing voltage (voltage required to ensure the potential unevenness removing ability) applied to potential unevenness removing sheet 21 was conducted using the image forming apparatus according to the embodiment.

The potential unevenness removing effect appears when a potential difference between a surface potential Vs of image carrier 11 and a voltage Ve applied to potential unevenness removing sheet 21 at the time of arrival at a potential unevenness removing position becomes equal to or greater than a certain potential difference. When Vth (discharge start potential difference) is a potential difference at which the potential unevenness removing effect starts to appear, Vth of the initial image carrier before the printing durability test was 600[V], and Vth of the image carrier in the end stage of printing durability was 500[V], in the image forming apparatus according to the embodiment.

In order to determine the proper range of the potential unevenness removing voltage by the test, it was evaluated whether or not each of positive memory, poor potential unevenness removal (vertical lines) and negative memory occurred on the initial image carrier and the image carrier in the end stage of printing durability when voltage Ve (potential unevenness removing voltage) applied to the potential unevenness removing sheet was changed.

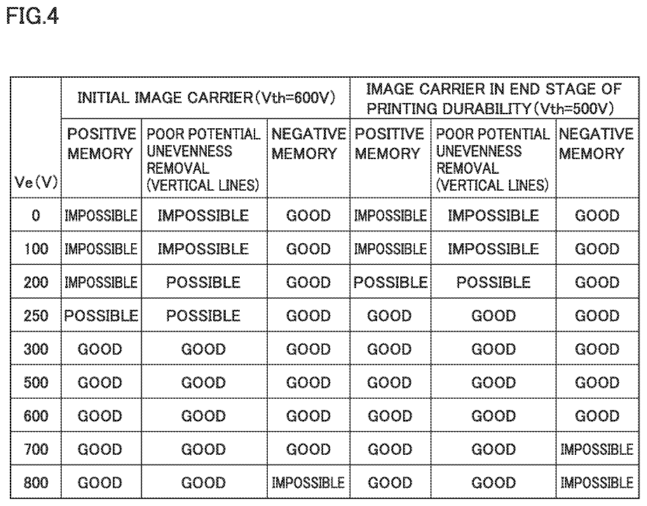

FIG. 4 shows a result of the test conducted to determine the proper range of the potential unevenness removing voltage. “Good” in FIG. 4 indicates that the evaluation result has no problem (the positive memory and the like do not occur). “Possible” indicates that actual use is possible. “Impossible” indicates that actual use is impossible.

It can be seen that when Ve is applied to the initial image carrier (the printing durability number of sheets of paper is zero), the positive memory, the negative memory and the poor potential unevenness removal do not occur in the range of 300≤Ve≤700. Furthermore, it can be seen that when Ve is applied to the image carrier in the end stage of printing durability (the printing durability number of sheets of paper is close to the end of the life), the positive memory, the negative memory and the poor potential unevenness removal do not occur in the range of 250≤Ve≤600.

As the printing durability number of sheets of paper becomes larger, the proper potential unevenness removing voltage that can ensure the potential unevenness removing function tends to become lower. This is because the film thickness of the image carrier is reduced due to printing durability, and thus, the positive memory and the like occur if the potential unevenness removing voltage is not lowered in accordance with the amount of reduction.

However, when the potential unevenness removing voltage is excessively lowered, the contact pressure between elastic portion 25 and image carrier 11 becomes lower and thus the cleaning property cannot be ensured. When the blade (elastic portion 25) wears out due to printing durability, the above-described contact pressure needs to be raised in accordance with the amount of wear. In order to raise the above-described contact pressure, it is necessary to increase the potential unevenness removing voltage of potential unevenness removing sheet 21 and increase the electrostatic attraction force of potential unevenness removing sheet 21.

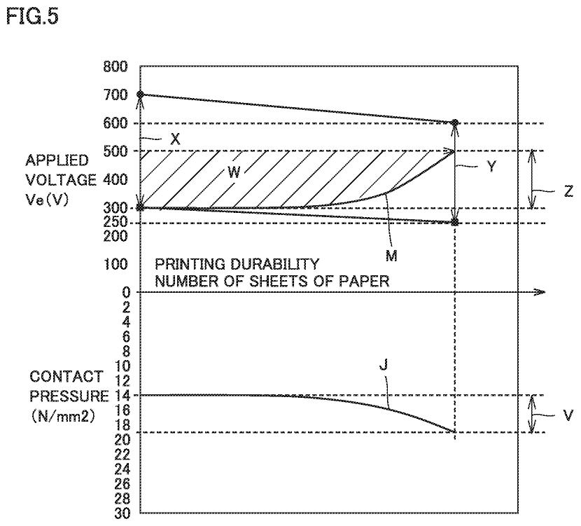

FIG. 5 shows a range of voltage Ve applied to potential unevenness removing sheet 21, to ensure both the potential unevenness removing ability and the cleaning ability. The horizontal axis represents the printing durability number of sheets of paper. The upper-side vertical axis represents the voltage (Ve) applied to potential unevenness removing sheet 21, and the lower-side vertical axis represents the contact pressure between elastic portion 25 and image carrier 11.

Based on the result in FIG. 4, the proper range of the potential unevenness removing voltage to ensure the potential unevenness removing function is 300≤Ve≤700 (X in FIG. 5) in the case of the initial image carrier (the printing durability number of sheets of paper is zero), and 250≤Ve≤600 (Y in FIG. 5) in the case of the image carrier in the end stage of printing durability (the printing durability number of sheets of paper is close to the end of the life).

As shown in FIG. 5, as the printing durability number of sheets of paper becomes larger, elastic portion 25 wears out and the cleaning ability of cleaning portion 20 decreases, and thus, the above-described contact pressure needs to be raised (J in FIG. 5). That is, the voltage applied to potential unevenness removing sheet 21 needs to be increased (M in FIG. 5). When a proper range of the above-described contact pressure is, for example, not less than 14 [N/mm²] and not more than 19 [N/mm²] (V in FIG. 5), the voltage applied to potential unevenness removing sheet 21 must be set to be not less than 300[V] and not more than 500[V] (Z in FIG. 5).

As shown in FIG. 5, it can be seen that applied voltage Ve that can ensure both the potential unevenness removing ability and the cleaning ability is 300≤Ve≤500 in the case of the initial image carrier (Z in FIG. 5). Since applied voltage Ve required to ensure the cleaning ability is 500[V] in the case of the image carrier in the end stage of printing durability, applied voltage Ve must be brought closer to 500[V] as the end stage of printing durability approaches. Therefore, the range of applied voltage Ve that can ensure both the potential unevenness removing ability and the cleaning ability is a region W (diagonally shaded portion) in FIG. 5.

(Function and Effect)

As shown in FIG. 2, the voltage is applied to potential unevenness removing sheet 21 by power supply portion 22, and the electrostatic attraction force is thereby generated between potential unevenness removing sheet 21 and image carrier 11. Potential unevenness removing sheet 21 is provided to be joined to plate spring 24 of cleaning portion 20, and thus, plate spring 24 is pulled in the direction of coming closer to image carrier 11.

As a result, elastic portion 25 is pressed against image carrier 11 and the contact pressure between elastic portion 25 and image carrier 11 increases. Therefore, the ability to scrape the toner remaining on the surface of image carrier 11 can be enhanced. Therefore, the cleaning ability of cleaning portion 20 is enhanced. The enhancement of the cleaning ability of cleaning portion 20 makes it possible to suppress an uncleaned part. As a result, the occurrence of image noise can be suppressed.

Even when elastic portion 25 wears out and the cleaning ability of cleaning portion 20 decreases, the electrostatic attraction force can be controlled and the contact pressure between elastic portion 25 and image carrier 11 can be increased by adjusting the voltage applied to potential unevenness removing sheet 21. As a result, even when the cumulative number of printed recording media increases, the cleaning ability of cleaning portion 20 can be ensured by increasing the voltage applied to potential unevenness removing sheet 21. Therefore, the frequency of replacement of cleaning portion 20 can be reduced. Thus, the running cost of image forming apparatus 100 can be reduced.

Furthermore, potential unevenness removing sheet 21 has both the function of removing potential unevenness from image carrier 11 and the function of increasing the contact pressure between elastic portion 25 and image carrier 11. Therefore, there is no need to employ another mechanism for increasing the above-described contact pressure, and thus, a structure of image forming apparatus 100 can be simplified (made compact). Furthermore, the manufacturing cost of image forming apparatus 100 can be reduced.

Such a structure that the contact pressure between elastic portion 25 and image carrier 11 is electrically controlled allows fine adjustment, and thus, the accuracy when adjusting the above-described contact pressure is enhanced.

The first charging portion according to the embodiment has a sheet shape. Since the first charging portion has a sheet shape, the first charging portion itself is easily deformed flexibly and the other end 21b of the first charging portion is provided along the surface of image carrier 11. As a result, a contact area between the first charging portion and image carrier 11 can be ensured, and thus, the electrostatic attraction force is easily generated.

Furthermore, since the first charging portion is deformed flexibly, the first charging portion is pulled more easily with the rotation of image carrier 11, as compared with the case in which the first charging portion has a rod shape and the like (the case in which the first charging portion has greater rigidity).

Second charging portion 15 is arranged on the downstream side of the first charging portion (potential unevenness removing sheet 21) in rotation direction DR1. The surface potential of image carrier 11 after the transfer residual toner is cleaned has potential unevenness. Therefore, if the surface potential of image carrier 11 is not made uniform before image carrier 11 is charged by second charging portion 15, the electrostatic latent image has unevenness, which causes image unevenness.

The surface potential of image carrier 11 to which the toner image has been transferred by primary transfer roller 12 is set constant (zero) by the first charging portion (potential unevenness removing sheet 21), and then, image carrier 11 is charged by second charging portion 15. Therefore, the electrostatic latent image can be formed without unevenness.

The first charging portion is provided to be joined to plate spring 24. The first charging portion is joined to the position distant from elastic portion 25 toward the holder 23 side, and thus, the force of pulling cleaning portion 20 by the first charging portion is great. Thus, the force with which elastic portion 25 comes into contact with image carrier 11 is great. As a result, the contact pressure between elastic portion 25 and image carrier 11 is high.

The first charging portion is attached to the elastic portion 25 side with respect to joined region 23a. If the first charging portion is provided in joined region 23a, plate spring 24 cannot be bent even when the first charging portion is pulled. Since one end 21a of the first charging portion (potential unevenness removing sheet 21) is provided at a distance from joined region 23a toward the elastic portion 25 side, plate spring 24 can be reliably bent.

First controller 31 controls power supply portion 22 in accordance with the number of printed recording media (printing durability number of sheets of paper). As the printing durability number of sheets of paper becomes larger, elastic portion 25 wears out and the contact pressure between elastic portion 25 and image carrier 11 decreases. By increasing the voltage applied to the first charging portion as the above-described contact pressure becomes lower, the decrease in the above-described contact pressure can be suppressed. As a result, the cleaning ability of cleaning portion 20 can be ensured even when the printing durability number of sheets of paper becomes larger. Therefore, the frequency of replacement of cleaning portion 20 can be reduced.

Second controller 32 controls power supply portion 22 in accordance with a change in at least one of the temperature and the humidity around cleaning portion 20. The temperature and the humidity around cleaning portion 20 affect the above-described contact pressure and the like. By adjusting the voltage applied to the first charging portion in accordance with the temperature and the humidity around cleaning portion 20, the electrostatic attraction force can be controlled with high precision.

Third controller 33 can estimate the film thickness of image carrier 11 and detect the life of cleaning portion 20 in accordance with the result of current detecting portion 34 (value of the current flowing through the first charging portion). As a result, the life of cleaning portion 20 can be detected with high precision.

Tip 24a of plate spring 24 is provided to protrude from tip 25a of elastic portion 25. Since an entire rear surface (surface opposite to a surface facing toward image carrier 11) of elastic portion 25 is supported by plate spring 24, elastic portion 25 comes into contact with image carrier 11 uniformly. As a result, the cleaning ability is enhanced.

Tip 24a is provided to prevent discharge from occurring between tip 24a and image carrier 11. When the surface potential of image carrier 11 is determined, a distance at which discharge does not occur between image carrier 11 and elastic portion 25 can be determined in accordance with the Paschen's law. As a result, discharge occurring between image carrier 11 and tip 24a can be suppressed reliably.

Tip 24a is preferably covered with an elastic member. As a result, discharge occurring between image carrier 11 and tip 24a can be suppressed more reliably.

As shown in FIG. 3, the material of the first charging portion is preferably silicon. By using silicon as the material of the first charging portion, the electrostatic attraction force is easily controlled.

### Second Embodiment

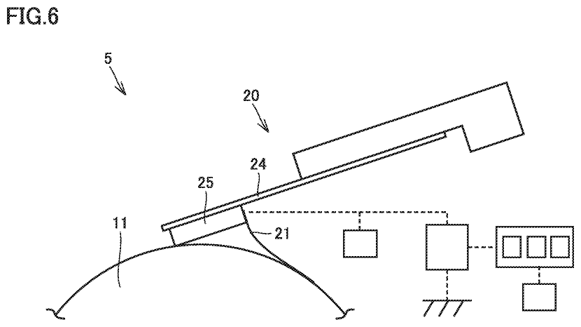

FIG. 6 is a schematic view of imaging unit 5 according to a second embodiment. Unlike potential unevenness removing sheet 21 according to the first embodiment, potential unevenness removing sheet 21 according to the second embodiment is provided at elastic portion 25.

Imaging unit 5 according to the second embodiment also produces an effect similar to that of imaging unit 5 according to the first embodiment.

### Third Embodiment

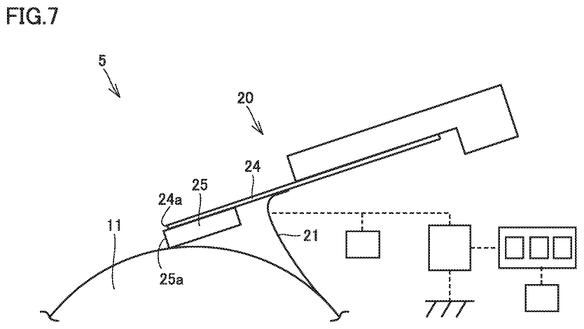

FIG. 7 is a schematic view of imaging unit 5 according to a third embodiment. Unlike cleaning portion 20 according to the first embodiment, tip 25a of elastic portion 25 according to the third embodiment is provided to protrude from tip 24a of plate spring 24, when viewed in the axial direction of image carrier 11. As a result, discharge occurring between image carrier 11 and plate spring 24 can be suppressed reliably.

(Others)

Although the first charging portion has a sheet shape (the first charging portion corresponds to potential unevenness removing sheet 21) in the embodiments, the present disclosure is not limited thereto. The first charging portion may have, for example, a rod shape, or may be configured such that a plurality of threads are provided over the axial direction of image carrier 11 (a plurality of threads are arranged side by side in a strip form).

The first charging portion (potential unevenness removing sheet 21) may be configured to further have the function of second charging portion 15 (function of charging image carrier 11 to form the electrostatic latent image), in addition to the potential unevenness removing function. That is, the first charging portion may be configured to also serve as second charging portion 15. In this case, second charging portion 15 does not need to be arranged, and thus, the cost of image forming apparatus 100 can be reduced.

An image forming apparatus according to the present disclosure includes: an image carrier; a first charging portion; and a cleaning portion. The image carrier is configured to be rotatable. The cleaning portion is configured to come into contact with the image carrier to thereby clean the image carrier. The first charging portion is arranged on a downstream side of the cleaning portion in a rotation direction of the image carrier. The first charging portion is configured to charge the image carrier. The first charging portion is provided at the cleaning portion. A voltage is applied to the image carrier by the first charging portion, and the cleaning portion is thereby pressed against the image carrier.

In the image forming apparatus, the first charging portion has a sheet shape.

In the image forming apparatus, a material of the first charging portion is silicon.

In the image forming apparatus, the voltage of negative polarity is applied to the image carrier by the first charging portion.

The image forming apparatus further includes a second charging portion arranged on a downstream side of the first charging portion in the rotation direction, and configured to charge the image carrier.

In the image forming apparatus, the cleaning portion includes an elastic portion configured to come into contact with the image carrier, and a plate spring configured to support the elastic portion. The first charging portion is provided at the elastic portion.

In the image forming apparatus, the cleaning portion includes an elastic portion configured to come into contact with the image carrier, and a plate spring configured to support the elastic portion. The first charging portion is provided to be joined to the plate spring.

In the image forming apparatus, the cleaning portion further includes a holder joined to the plate spring. The first charging portion is attached to the elastic portion side with respect to a joined portion of the plate spring and the holder, when viewed in an axial direction of the image carrier.

The image forming apparatus further includes: a power supply portion; and a first controller. The power supply portion is configured to apply a voltage to the first charging portion. The first controller is configured to control the power supply portion in accordance with the number of printed recording media.

The image forming apparatus further includes: a power supply portion configured to apply a voltage to the first charging portion; and a second controller configured to control the power supply portion in accordance with a change in at least one of temperature and humidity around the cleaning portion.

The image forming apparatus further includes: a current detecting portion configured to detect a current flowing through the first charging portion; and a third controller configured to detect a life of the cleaning portion in accordance with a result of the current detecting portion.

In the image forming apparatus, the cleaning portion includes an elastic portion configured to come into contact with the image carrier, and a plate spring configured to support the elastic portion. A tip of the plate spring is provided to protrude from a tip of the elastic portion, when viewed in an axial direction of the image carrier.

In the image forming apparatus, the tip of the plate spring is provided to prevent discharge from occurring between the tip of the plate spring and the image carrier.

In the image forming apparatus, the tip of the plate spring is covered with an elastic member.

In the image forming apparatus, the cleaning portion includes an elastic portion configured to come into contact with the image carrier, and a plate spring configured to support the elastic portion. A tip of the elastic portion is provided to protrude from a tip of the plate spring, when viewed in an axial direction of the image carrier.

According to the present disclosure, an image forming apparatus with reduced cost can be achieved.

Although embodiments of the present disclosure have been described and illustrated in detail, the disclosed embodiments are made for purposes of illustration and example only and not limitation. The scope of the present disclosure should be interpreted by terms of the appended claims.

What is claimed is:

1. An image forming apparatus comprising:
an image carrier configured to be rotatable;
a cleaning portion configured to come into contact with the image carrier to thereby clean the image carrier; and
a first charging portion arranged on a downstream side of the cleaning portion in a rotation direction of the image carrier, and configured to charge the image carrier,
the first charging portion being provided at the cleaning portion,
a voltage being applied to the image carrier by the first charging portion, and the cleaning portion being thereby pressed against the image carrier.

2. The image forming apparatus according to claim 1, wherein
the first charging portion has a sheet shape.

3. The image forming apparatus according to claim 1, wherein
a material of the first charging portion is silicon.

4. The image forming apparatus according to claim 1, wherein
the voltage of negative polarity is applied to the image carrier by the first charging portion.

5. The image forming apparatus according to claim 1, further comprising
a second charging portion arranged on a downstream side of the first charging portion in the rotation direction, and configured to charge the image carrier.

6. The image forming apparatus according to claim 1, wherein
the cleaning portion includes an elastic portion configured to come into contact with the image carrier, and a plate spring configured to support the elastic portion, and
the first charging portion is provided at the elastic portion.

7. The image forming apparatus according to claim 1, wherein
the cleaning portion includes an elastic portion configured to come into contact with the image carrier, and a plate spring configured to support the elastic portion, and
the first charging portion is provided to be joined to the plate spring.

8. The image forming apparatus according to claim 7, wherein
the cleaning portion further includes a holder joined to the plate spring, and
the first charging portion is attached to the elastic portion side with respect to a joined portion of the plate spring and the holder, when viewed in an axial direction of the image carrier.

9. The image forming apparatus according to claim 1, further comprising:
a power supply portion configured to apply the voltage to the first charging portion; and
a first controller configured to control the power supply portion in accordance with the number of printed recording media.

10. The image forming apparatus according to claim 1, further comprising:
a power supply portion configured to apply the voltage to the first charging portion; and
a second controller configured to control the power supply portion in accordance with a change in at least one of temperature and humidity around the cleaning portion.

11. The image forming apparatus according to claim 1, further comprising:
a current detecting portion configured to detect a current flowing through the first charging portion; and
a third controller configured to detect a life of the cleaning portion in accordance with a result of the current detecting portion.

12. The image forming apparatus according to claim 1, wherein
the cleaning portion includes an elastic portion configured to come into contact with the image carrier, and a plate spring configured to support the elastic portion, and
a tip of the plate spring is provided to protrude from a tip of the elastic portion, when viewed in an axial direction of the image carrier.

13. The image forming apparatus according to claim 12, wherein
the tip of the plate spring is provided to prevent discharge from occurring between the tip of the plate spring and the image carrier.

14. The image forming apparatus according to claim 12, wherein
the tip of the plate spring is covered with an elastic member.

15. The image forming apparatus according to claim 1, wherein
the cleaning portion includes an elastic portion configured to come into contact with the image carrier, and a plate spring configured to support the elastic portion, and
a tip of the elastic portion is provided to protrude from a tip of the plate spring, when viewed in an axial direction of the image carrier.
